(19) United States
(12) Patent Application Publication
(10) Pub. No.: US 2003/0127185 A1
(43) Pub. Date: Jul. 10, 2003

(54) Method for applying retroreflective target to a surface

(76) Inventor: Walter N. Bakly JR., La Canada Flintridge, CA (US)

Correspondence Address: Irving Keschner, Suite 1150, 21515 Hawthorne Boulevard, Torrance, CA, 90503, US

(21) Appl. No.: 10/036,167

(22) Filed: Jan. 4, 2002

(51) Int. Cl. B65C 1/00; B32B 31/00

(52) U.S. Cl. 156/297

(57) ABSTRACT

A method for transferring retroreflective assemblies in a predetermined sequence to a target. The target assemblies each comprise, in a preferred embodiment, a transfer sheet having openings formed therein, retroreflective targets being positioned in the openings, and a base member having a first surface which adheres to the bottom surface of the transfer member, a pressure sensitive adhesive layer being secured to the second surface of said base member. The assembled targets are positioned on a liner in a predetermined pattern and the liner is then wound in a roll in a manner such that the targets are positioned on the outside of the roll. When the targets are to be applied to a surface, the roll is unwound with the target assemblies facing the surface, the target assemblies then being forced against the surface such that the adhesive secures the target assemblies thereto. When the liner is removed, the targets remain secured to the surface in a predetermined sequence.

### BACKGROUND OF THE INVENTION

1. Field of the Invention

The present invention provides a method for securing retroreflective targets to a surface, the targets being variably positioned with respect to each other on a wound tape.

2. Description of the Prior Art

Retroreflective materials are utilized for many purposes, such as for safety, in manufacturing and for decorations. For example, in the fabrication of aircraft components, aligned details and mold lines must be validated to ensure proper fabrication of the components. In one technique, as set forth in U.S. Pat. No. 5,202,168 to Turner et al, a retroreflective target tape having a plurality of circular reflective targets formed on a mylar sheet is disclosed. The reflective targets are formed on a sheet material and then cut into a plurality of strips, each strip having a single row of spaced reflective target dots along its length. The reflective dots are, is should be noted, formed from a sheet of high gain reflective material. The cut strip is then prepared and applied directly to the aircraft.

The retroreflective target tape disclosed in the '168 patent is fabricated in the form of an elongated sheet, the sheet being cut into desired lengths by an operator and then applied to the aircraft as noted. However, there are instances in which it is desired to have the retroreflective target tape in a pre-cut form and capable of being easily stored and then transported to a location where the targets are to be applied to a surface. In addition, the targeting has a continuous backing which limits its application to surfaces that are flat or cylindrical. The spacing of the reflectors (targets) becomes expensive as the reflector material is scraped while the spaces are created. The spacing in this configuration is precise and can only be changed with new tooling.

What is thus desired is to provide a method of applying retroreflective targets with the spacing therebetween independent of the target, or application surface construction.

### SUMMARY OF THE PRESENT INVENTION

The present invention provides a method for transferring retroreflective members, formed as an assembly, in a predetermined sequence to a target surface. The target assembly, in a preferred embodiment, comprises a transfer sheet having openings formed therein, retroreflective targets positioned in the openings and a base member adhering to the bottom surface of the transfer member, a pressure sensitive adhesive layer being secured to the second surface of said base member. The assembled targets are positioned on a liner in a predetermined pattern and the liner is then wound in a roll in a manner such that the targets are positioned on the outside of the roll. When the targets are to be applied to a surface, the roll is unwound with the pressure surface adhesive facing the surface, the targets then being pushed against the surface such that the adhesive secures the targets thereto.

The present invention thus provides a simple and cost efficient method for applying retroreflective targets to a surface with the spacing therebetween independent of the target surface construction allowing for a wide range of spacing. The target assemblies are discrete and applied independently which allows the targets in turn to be applied to any shaped surface configuration.

### BRIEF DESCRIPTION OF THE DRAWINGS

For a better understanding of the present invention as well as other objects and further features thereof, reference is made to the following description which is to be read in conjunction with the accompanying drawing therein:

FIG. 1 is an assembly view of a retroreflective assembly member constructed in accordance with the preferred embodiment of the present invention;

FIG. 2 is the assembled member of FIG. 1 in sectional form;

FIG. 3 shows assembled transfer members positioned on a liner, or carrier, tape;

FIG. 4 illustrates the liner tape of FIG. 3 formed in a roll;

FIG. 5 shows the target assemblies of FIG. 4 ready for application to a surface;

FIG. 6 shows the target assemblies of FIG. 5 applied to a surface;

FIG. 7 shows an assembly view of a retroreflective assembly member constructed in accordance with a second embodiment of the present invention;

FIG. 8 is the assembly member of FIG. 7;

FIG. 9 illustrates assembled targets positioned on a liner tape;

FIG. 10 illustrates the liner tape of FIG. 9 formed in a roll;

FIG. 11 shows the target assemblies of FIG. 10 ready for application to a surface; and

FIG. 12 shows the target assemblies of FIG. 11 applied to a surface.

### DESCRIPTION OF THE INVENTION

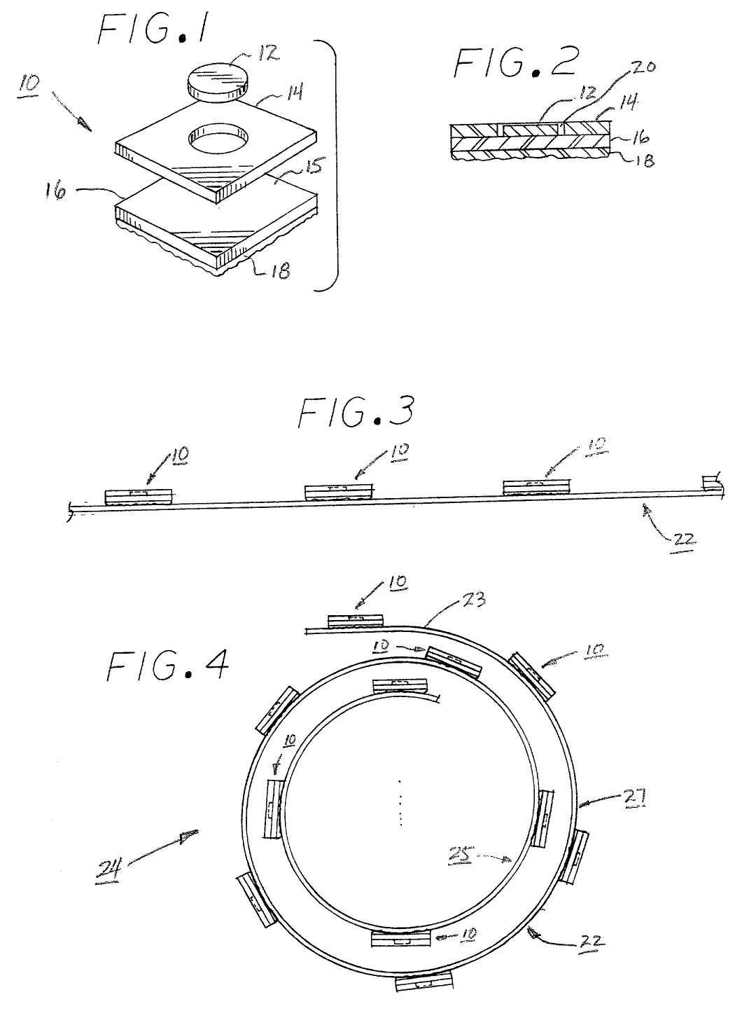

Referring now to FIGS. 1-6, a preferred embodiment of the present invention is illustrated. In particular, FIG. 1 is an exploded view of the retroreflective member 10 portion of the invention, member 10 comprising a cylindrical disc shaped retroreflective member 12, transfer layer 14, base member 16 and a pressure sensitive adhesive material 18 attached to the bottom surface of base member 16. FIG. 2 illustrates the assembled member 10, retroreflective member 12 being nested within opening 20 formed in transfer member 14 in a manner such that retroreflective member 12 is secured within opening 20. Transfer layer 14 is laminated to surface 15 of base member 16.

FIG. 3 illustrates a plurality of spaced apart reflective members 10 secured by adhesive material 18 to a liner member 22 and FIG. 4 illustrates liner member 22 with members 10 thereon, liner 22 being formed as a roll 24 for ease of storage and transport to the application site. The inside surface 23 of liner member 22 has target assemblies 10 secured thereto as illustrated (although roll portions 25 and 27 are shown spaced apart, they are in fact spaced so that portions so that, for example, the target assemblies 10 secured to roll portion 25 are in contact with the adjacent liner material 22).

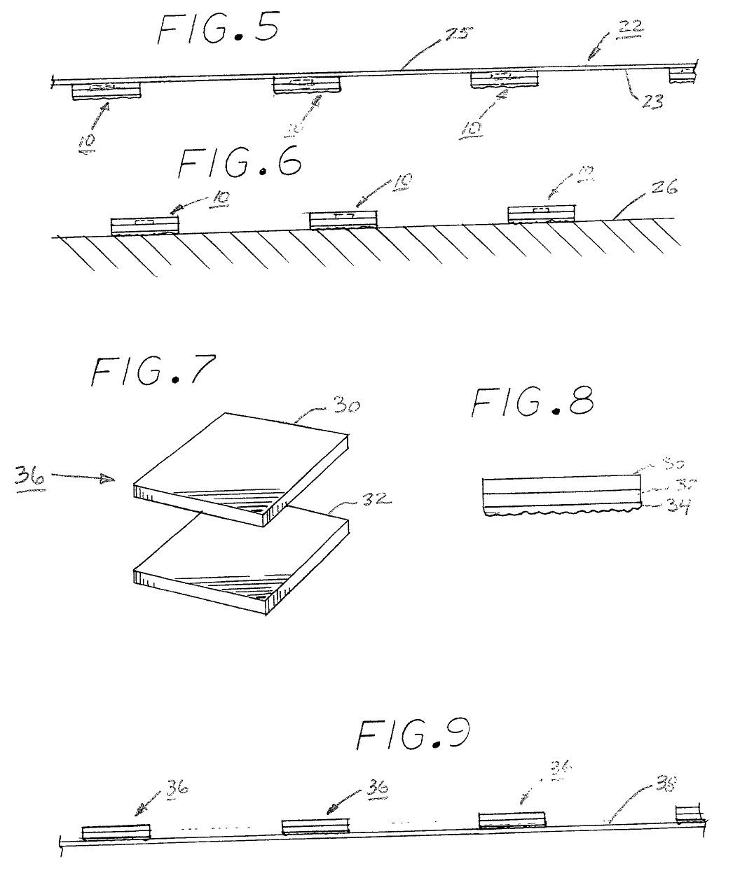

FIG. 5 illustrates roll 24 unwound and positioned in a manner such that the reflective members 10 are ready for application to a surface 26 with outside surface 25 of liner member 22 facing away from the target surface and FIG. 6 illustrates members 10 applied to a surface 26. In the preferred embodiment, the retroflective materials comprise an aluminum based material made by the 3M Company, Mineapolis, Minn., part number 7610 and the base material is Kapton tape (Kapton is a registered trademark of E. I. Du Pont De Nemours, Wilimington, Del. for a polyimide film) with a silicon pressure sensitive adhesive attached thereto. Transfer medium 14 is a double coated tape constructed to adhere to the target and liner member 22 to allow the transfer of the target at its final application to the desired surface. The liner member 22 can be either paper or plastic as determined by the targets and adhesives being used.

Examples of surfaces to which targets have been successfully transferred include aerospace composites, metals and plastics.

Retroreflective member 10 is fabricated as follows:

1. Base member 16 is applied to liner member 22;

2. The die-cut transfer layer 14 is, laminated to the base member 16;

3. Retroreflectors 12 are placed in transfer layer 14; and

4. Individual target assemblies 10 are placed on liner member 22 to form roll 24.

As the target assemblies are wound into the roll; they are wound on the outside of the liner. Thus, the final outside layer of roll 24 is the liner member 12.

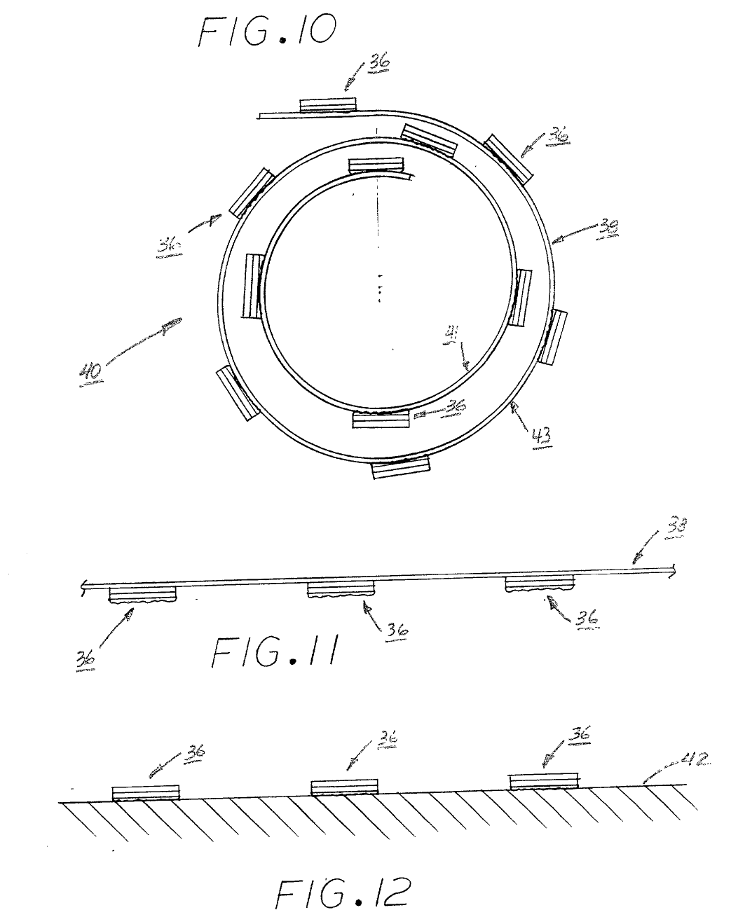

FIGS. 7-12 illustrate a second embodiment of the invention wherein the target retroreflector is built into the base layer. In particular, FIG. 7 shows an assembly view of a target assembly 36 comprising transfer layer 30 and a target member 32 formed as part of base layer having a pressure sensitive layer 34 formed on the bottom surface of target member 32 (FIG. 8). FIG. 9 illustrates a plurality of target members 36 secured to a liner member 38 via adhesive layers 32 and FIG. 10 shows the liner 38 member formed into a roll 40 (although the roll portions 41 and 43 are shown spaced apart, they are in fact spaced so that for example, the target assemblies 36 on section 41 are in contact with the adjacent liner member 38). FIG. 11 shows target members 36 in position for application to a surface and FIG. 12 illustrates spaced apart target member applied to a surface 42.

Although the present invention is particularly useful in applying retroreflective members to a surface, it also can be utilized to apply other items to a surface. For example, a decorative piece can be used in place of the retroreflective member and applied to decorate a ceramic surface or plate. In addition, the method of the present invention can be utilized to apply thermal transfers to decorate fabric.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A method for preparing a plurality of target assemblies for application to a surface, each comprising the steps of:
providing an application member;
providing a transfer member, an opening being formed in said transfer member, said application member being positioned within said opening;
providing a base member having first and second surfaces, a pressure sensitive material being formed on said first surface of said base member, said transfer member being secured to said second surface of said base member; and
repeating the above steps to form additional target assemblies.

2. The method of claim 1 further including the step of securing said assemblies to the surface of a liner member in a predetermined spaced apart arrangement.

3. The method of claim 2 further including the step of forming said liner member in a roll configuration.

4. The method of claim wherein said application member comprises a retroreflective member.

5. A method for preparing a plurality of target assemblies for application to a surface comprising the steps of:
providing a transfer layer;
providing a base member comprising an application member and having first and second surfaces, a pressure sensitive material being formed on said first surface of said base member, said transfer member being secured to said second surface of said base member; and
repeating the above step to form additional target assemblies

6. The method of claim 5 further including the step of securing said target assemblies to the surface of a liner member in a predetermined spaced apart arrangement.

7. The method of claim 6 further including the step of forming said liner in a roll configuration.

8. The method of claim 5 wherein said application member comprises a retroreflective member.
